(19) United States
(12) Patent Application Publication
(10) Pub. No.: US 2008/0155675 A1
(43) Pub. Date: Jun. 26, 2008

(54) SECURITY MECHANISM FOR ONE-TIME SECURED DATA ACCESS

(75) Inventors: Arthur Tu, Taipei City (TW); Jen-Yau Kuo, Hsinchu City (TW); Jung-Sing Jwo, Kaohsiung City (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 11/780,347

(22) Filed: Jul. 19, 2007

(30) Foreign Application Priority Data
Dec. 26, 2006 (TW) 095148338

(51) Int. Cl. H04L 9/32

(52) U.S. Cl. 726/9

(57) ABSTRACT

A security mechanism for one-time secured data access, using re-writable/readable contactless tags with corresponding software and hardware implementations to provide a multi-layered one-time secured trading/service for various business transaction modes, such as business-to-business (B2B), business-to-consumer (B2C), and homo/hetero-business, so that information security of a company, a government department, or even a person can be enhanced while the complexity of data security control is greatly reduced.

### BACKGROUND OF THE INVENTION

1. Field of the Invention

The present invention generally relates to a security mechanism for one-time secured data access and, more particularly, to a security mechanism for one-time secured data access using writable/readable contactless tags with corresponding software and hardware implementations to provide a multi-layered one-time secured trading/service for various business transaction modes, such as business-to-business (B2B), business-to-consumer (B2C) and homo/hetero-business.

2. Description of the Prior Art

With the rapid development in e-commerce, great considerations are taken into account for various business transaction modes such as business-to-business (B2B), business-to-consumer (B2C) and homo/hetero-business when it comes to protection and sharing of secured data of the customers.

The currently used electronic token, stored in radio-frequency identification (RFID) tags, sensor tags or the like, is simply for authentication. For example, U.S. Pat. Pub. No. 2005/105734 “Proximity authentication system”, U.S. Pat. Pub. No. 2004/002894 “Personnel and vehicle identification system using three factors of authentication”, and European Pat. No. WO0199410 “Token-based personalization of smart appliances” disclose techniques for authentication using RFID.

### SUMMARY OF THE INVENTION

It is an object of the present invention to provide a security mechanism for one-time secured data access using writable/readable contactless tags with corresponding software and hardware implementations to provide a multi-layered one-time secured trading/service for various business transaction modes, such as business-to-business (B2B), business-to-consumer (B2C) and homo/hetero-business.

In order to achieve the foregoing object, the present invention provides a security mechanism for one-time secured data access, comprising: a token card, containing writable/readable tags; a token access device, for accessing a token from the token card; and a central system, for managing the token access device.

In order to achieve the foregoing object, the present invention provides a subscriber registration process using a security mechanism for one-time secured data access, comprising steps of:
a. an applicant going to a local access point comprising a token access device;
b. the applicant providing a registration officer with identification and authorization documents;
c. the registration officer verifying the documents, taking a picture of the applicant and performing a security check on the applicant;
d. a central system verifying whether the applicant passes verification and the security check;
e. rejecting application if the applicant does not pass the verification and the security check and stopping the application process, otherwise proceeding with Step f;
f. creating and storing a personal profile of the applicant in the central system;
g. issuing a token card with a unique card holder ID and a private key to the applicant;
h. testing the token card and the overall system; and
i. the applicant successfully enrolling in the central system.

In order to achieve the foregoing object, the present invention provides a token initialization process using a security mechanism for one-time secured data access, comprising steps of:
a. logging onto a web portal to select desired services;
b. choosing a token initialization option from the web portal;
c. placing a token card on a token card cassette of a token access device;
d. the token access device transmitting an ID and a private key to a central system for authentication;
e. the central system verifying whether the token card is valid;
f. rejecting the token card and stopping the initialization process if the central system verifies the token card is invalid, otherwise proceeding with Step g;
g. the central system creating a unique electronic token corresponding to the services selected by a card holder;
h. the central system transmitting the token to the requesting token access device and the token access device writing the electronic token into a tag memory of the token card;
i. the central system verifying whether the token is successfully written into the token card and returning to Step h if writing is failed, otherwise proceeding with Step j; and
j. the token being successfully written into the token card and the web portal displaying service related information.

In order to achieve the foregoing object, the present invention provides a secured data access process using a local service point of a security mechanism for one-time secured data access, comprising steps of:
a. deciding a local service point to visit and going to the local service point;
b. placing a token card on a token access device in the local service point;
c. the token access device transmitting an ID and a private key to a central system for authentication;
d. the central system verifying whether the token card is valid;
e. rejecting a service and stopping the secured data access process if the central system verifies the token card is invalid, otherwise proceeding with Step f;
f. the token access device requesting information regarding a card holder by transmitting a token key and a corresponding local service ID to the central system;
g. the central system authenticating a request from the local service point by verifying the service ID and an electronic token (token string);
h. the central system verifying whether a valid service is matched with a valid token;
i. rejecting a service and stopping the secured data access process if the central system verifies the valid service is not matched with the valid token, otherwise proceeding with Step j;
j. the central system retrieving a specific portion of profile information of the card holder related to a specific local service from a database and associating the service ID with the token string;
k. the central system encoding the retrieved information and transmitting the encoded retrieved information to the requesting local service point;
l. the token access device of the requesting local service point receiving the encoded information, decoding the information, displaying the information and finally informing an associating local service system; and
m. the token access device clearing all data related to the token after the service ends and the token card is taken out of the token access device.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a schematic diagram showing a security mechanism for one-time secured data access according to the present invention;

FIG. 2 is a schematic diagram showing a token access device with associated software/hardware connected thereto according to the present invention;

FIG. 3 is a schematic diagram showing a tag in a token card with associated software/hardware connected thereto according to the present invention;

FIG. 4 is a schematic diagram showing connection of a token, service and data access privilege according to the present invention;

FIG. 5 is a flow-chart showing a subscriber registration process according to the present invention;

FIG. 6 is a flow-chart showing a token initialization process according to the present invention; and

FIG. 7 is a flow-chart showing a secured data access process using a local service point according to the present invention.

### DETAILED DESCRIPTION OF THE PREFERRED EMBODIMENT

The present invention can be exemplified by the preferred embodiment as described hereinafter.

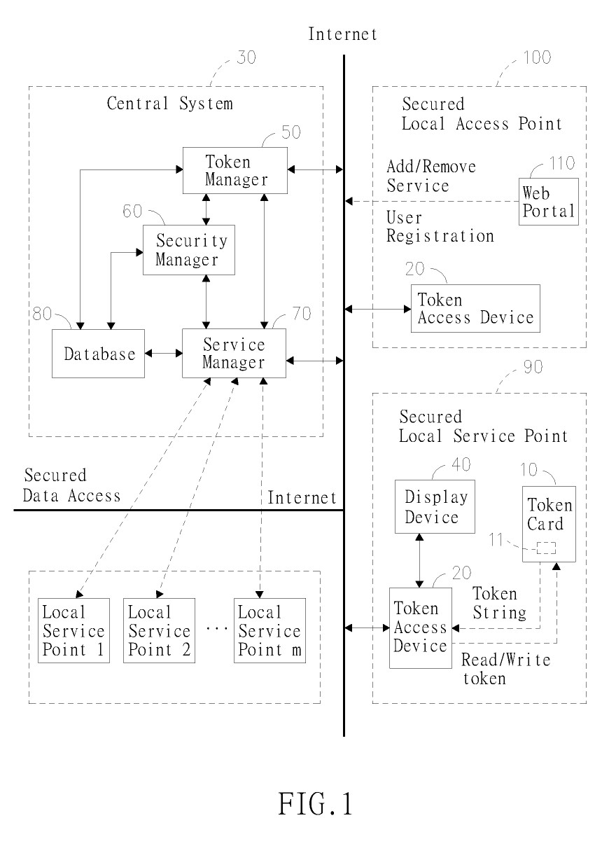

Please refer to FIG. 1, which is a schematic diagram showing a security mechanism for one-time secured data access according to the present invention. Generally, a local service point 90 registers the service information (such as service ID, service content specification, etc) in a central system 30 in advance. After the subscriber/customer purchases a token card 10, he/she can bring the token card 10 to a local access point 100 to choose or buy related services and is granted with a privilege for a one-time service. Then, the card holder goes to the local service point 90, which is communicated with the local access point 100 and the central system 30 through Internet. Other local service points 1, 2, . . . , m are communicated with the central system 30 so as to provide the token card 10 with corresponding privileges for services.

In order to achieve the foregoing object, the local service point 90 comprises a token access device 20 for controlling the software and hardware for accessing a token from the token card 10. The token access device 20 is coupled to a display device 40 for displaying the access of the token access device 20. The display device 40 generally comprises a host and a monitor.

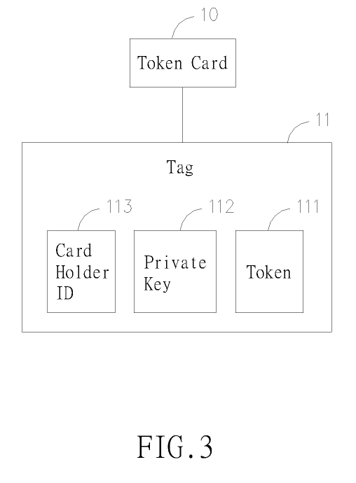

The token card 10 contains re-writable/readable tags 11, which can be contactless tags comprising at least one of RFID tags, contactless ID tags, sensor tags, RFID transponders and combination thereof. The RFID tags are compact with wireless communication capability so that the stored data can be checked through Internet for various applications. In the present invention, the central system 30 provides the token card 10 with a specific token 111, a private key 112 and a card holder ID 113 (as shown in FIG. 3). The token 111 is a token string, which is a specific string, for one-time service. The private key 112 is for subscriber authentication. The card holder ID 113 is the only ID for the token 11.

Referring to FIG. 1, the central system 30 is used for managing the token access device 20. The central system 30 comprises a token manager 50, a security manager 60, a service manager 70 and a database 80. The token manager 50 manages generation, usage, invalidation of the token and transmits the token to the token access device 20 in the local service point 90. The security manager 60 is used for authenticating identity of a card holder, verifying services allowed for the identity and managing information access privilege of each of the services. The security manager 60 is capable of performing encryption on information transmitted from the central system 30. The service manager 70 manages a service process comprising managing subscriber registration and adding, updating or deleting services. The database 80 is used for storing data comprising information of the token, service, security and historical information.

Moreover, the local access point 100 comprises a web portal 110 for providing network-linking for subscriber registration and adding, updating or deleting services. The token access device 20 is disposed in the local access point 100 for writing the token into the token card 10, wherein the token is generated after registration through Internet or service update.

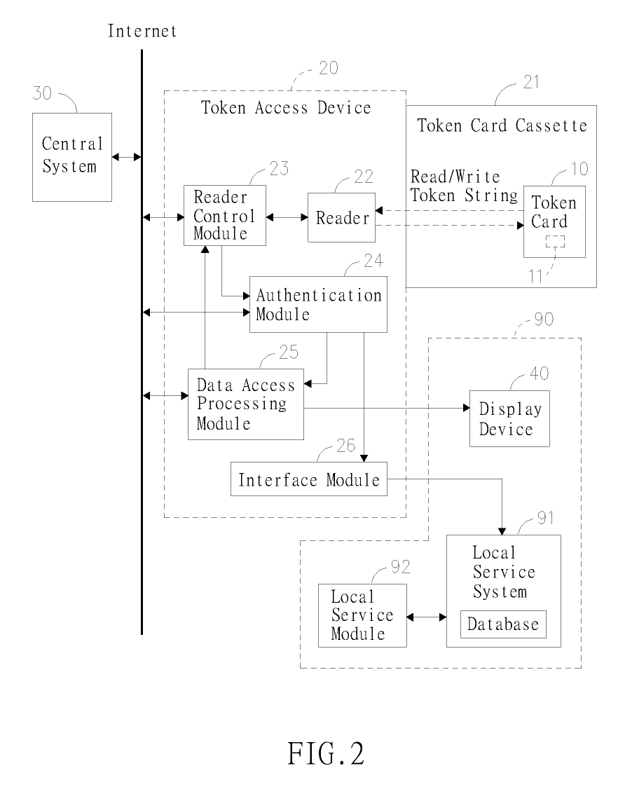

Please refer to FIG. 2, which is a schematic diagram showing a token access device 20 with associated software/hardware connected thereto according to the present invention. The token access device 20 comprises a token card cassette 21, a reader 22, a reader control module 23, an authentication module 24, a data access processing module 25 and an interface module 26. The reader control module 23, the authentication module 24, and the data access processing module 25 are coupled to the central system 30 through Internet.

The token card cassette 21 is used for communicating the token card 10 and the token access device 20. When the token card 10 is placed into the token card cassette 21, the read 22 is capable of reading the data stored in the tags 11 in the token card 10. The reader 22 comprises a transceiver antenna, a transceiver module and a control circuit (not shown) so as to transmit the data read from the tags 11 to the reader control module 23. The reader control module 23 controls the write/read operation of the reader 22 and receives the token transmitted from the central system 30.

The authentication module 24 is used for an authentication process of the token card 10. The authentication process is described later in this specification.

The data access processing module 25 processes a data access process and performs decryption on information of the central system 30. The data access processing module 25 is coupled to the display device in the local service point 90.

The interface module 26 communicates the token access device 20 and a local service system 91 in the local service point 90. The local service system 91 comprises a local service module for operating the local service system 91.

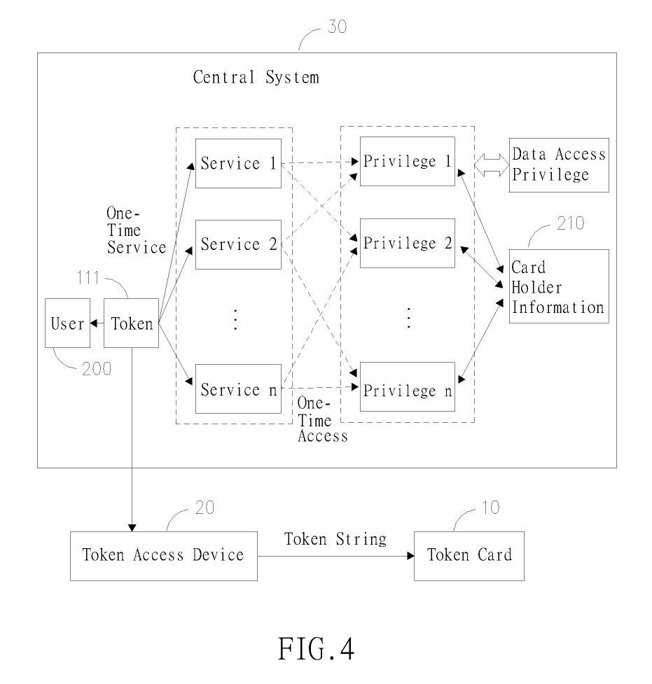

Please refer to FIG. 4, which is a schematic diagram showing connection of a token, service and data access privilege according to the present invention. The central system 30 transmits a token 111 corresponding to a card holder 200. The token 111 contains card holder information 210 according to services 1, 2, . . . , n allowed for the card holder 200, data access privileges 1, 2, . . . , n allowed for the services 1, 2, . . . , n. The card holder information 210 is stored in a database 80 in the central system 30 in FIG. 1. The central system 30 transmits the token 111 to the token access device 20. The token card contains a token string that is specifically encoded.

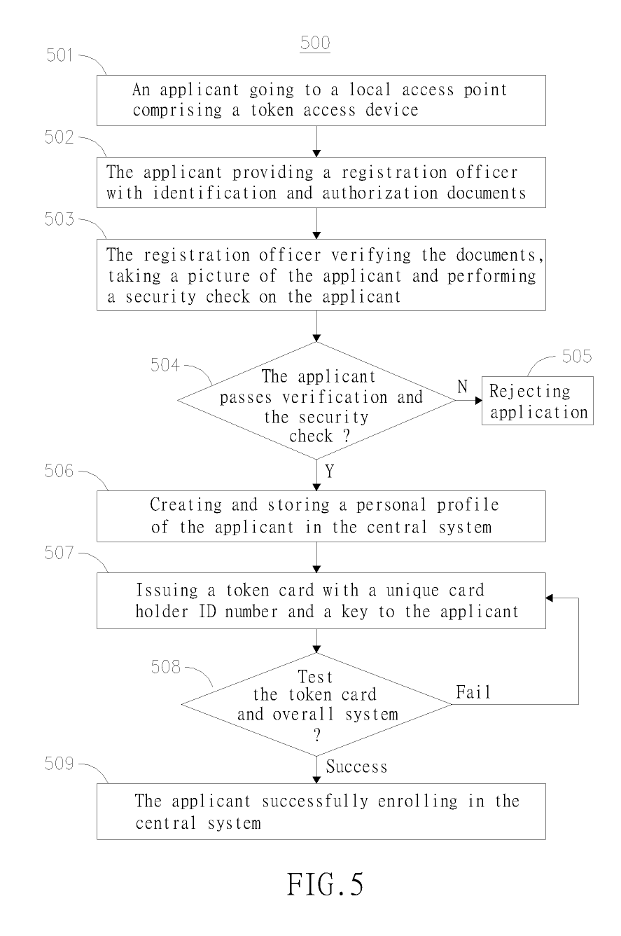

Please refer to FIG. 5, which is a flow-chart showing a subscriber registration process according to the present invention. The subscriber registration process 500 using a security mechanism for one-time secured data access comprises steps described hereinafter.

In Step 501, an applicant goes to a local access point comprising a token access device.

In Step 502, the applicant provides a registration officer with identification and authorization documents.

In Step 503, the registration officer verifies the documents, takes a picture of the applicant and performs a security check on the applicant.

In Step 504, a central system verifies whether the applicant passes verification and the security check.

In Step 505, application is rejected if the applicant does not pass the verification and the security check and the application process is stopped; otherwise the process proceeds with Step 506.

In Step 506, a personal profile of the applicant is created and stored in the central system.

In Step 507, a token card with a unique card holder ID and a private key to the applicant are issued.

In Step 508, the token card and the overall system are tested.

In Step 509, the applicant successfully enrolls in the central system.

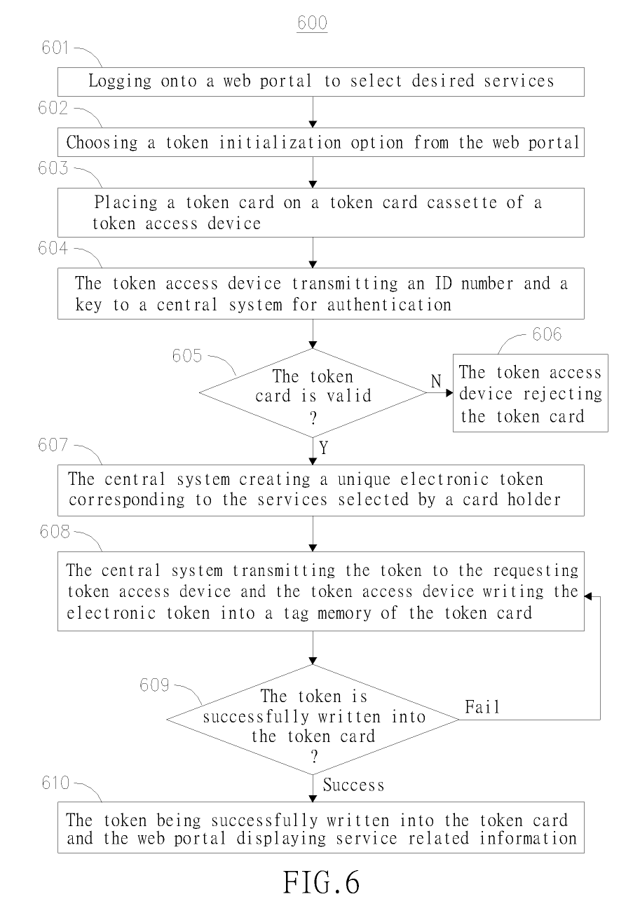

Please refer to FIG. 6, which is a flow-chart showing a token initialization process according to the present invention. The token initialization process 600 using a security mechanism for one-time secured data access comprises steps described hereinafter.

In Step 601, the user logs onto a web portal to select desired services.

In Step 602, a token initialization option is chosen from the web portal.

In Step 603, a token card is placed on a token card cassette of a token access device.

In Step 604, the token access device transmits an ID and a private key to a central system for authentication.

In Step 605, the central system verifies whether the token card is valid.

In Step 606, the token card is rejected and the initialization process is stopped if the central system verifies the token card is invalid; otherwise the process proceeds with Step 607.

In Step 607, the central system creates a unique electronic token corresponding to the services selected by a card holder.

In Step 608, the central system transmits the token to the requesting token access device and the token access device writes the electronic token into a tag memory of the token card.

In Step 609, the central system verifies whether the token is successfully written into the token card and the process returns to Step 608 if writing is failed; otherwise the process proceeds with Step 610.

In Step 610, the token is successfully written into the token card and the web portal displays service related information.

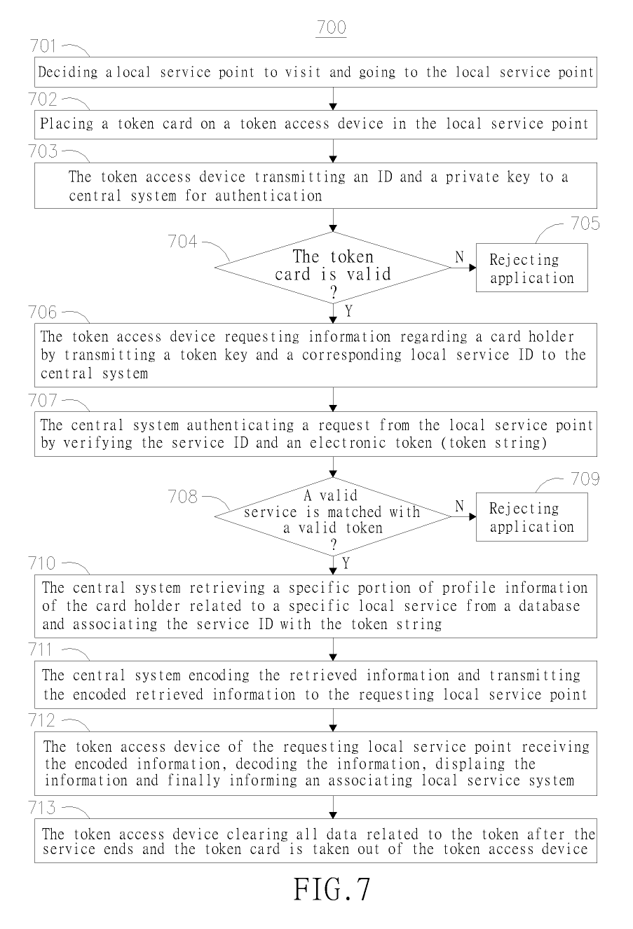

Please refer to FIG. 7, which is a flow-chart showing a secured data access process using a local service point according to the present invention. The secured data access process 700 using a local service point of a security mechanism for one-time secured data access comprises steps described hereinafter.

In Step 701, a user decides a local service point to visit and he/she goes to the local service point.

In Step 702, a token card is placed on a token access device in the local service point.

In Step 703, the token access device transmits an ID and a private key to a central system for authentication.

In Step 704, the central system verifies whether the token card is valid.

In Step 705, a service is rejected and the secured data access process is stopped if the central system verifies the token card is invalid; otherwise the process proceeds with Step 706.

In Step 706, the token access device requests information regarding a card holder by transmitting a token key and a corresponding local service ID to the central system.

In Step 707, the central system authenticates a request from the local service point by verifying the service ID and an electronic token (token string).

In Step 708, the central system verifies whether a valid service is matched with a valid token.

In Step 709, a service is rejected and the secured data access process is stopped if the central system verifies the valid service is not matched with the valid token; otherwise the process proceeds with Step 710.

In Step 710, the central system retrieves a specific portion of profile information of the card holder related to a specific local service from a database and the service ID is associated with the token string.

In Step 711, the central system encodes the retrieved information and transmits the encoded retrieved information to the requesting local service point.

In Step 712, the token access device of the requesting local service point receives the encoded information, decodes the information, displays the information and finally informs an associating local service system.

In Step 713, the token access device clears all data related to the token after the service ends and the token card is taken out of the token access device.

According to the above discussion, it is apparent that the present invention discloses a security mechanism for one-time secured data access using writable/readable contactless tags with corresponding software and hardware implementations to provide a multi-layered one-time secured trading/service for various business transaction modes, such as business-to-business (B2B), business-to-consumer (B2C) and homo/hetero-business.

The present invention can be used in the hotel business, for example. The proprietor stores and encodes information related to customers' interests and backgrounds in a computer. The customers select services and pay. These services include body fitness, medical treatment and banking. The proprietor provides each customer with a chip card, wherein a unique ID (i.e., the card holder ID 113 as shown in FIG. 3) for the customer is stored in the chip, and an electronic key (i.e., the private key 112 as shown in FIG. 3) for entering a room corresponding to the electronic key. The electronic key embedded in the chip card only allows the customer to enter the room for one-time service. If the customer wants to repeat the same service or change the service, he/she has to go back to the counter to re-select services and pay. Meanwhile, the electronic key in the chip card is updated. When the customer enters the room and is ready to enjoy the service, the waiter can view the customer information related to the services on the monitor so as to provide personalized service according to the customer's demand. The waiter cannot view any other information of the customer. For example, a financing consultant is allowed to view the customer's personal financial status only. When the services end and the customer is ready to leave, the customer's information related to the services is deleted immediately and the waiter can no longer view any information of the customer. When the customer carelessly loses the chip card and informs the waiter at the counter, the waiter can invalidate the card immediately and issue a new card to the customer so as to reduce any risk. Similarly, the present invention can be applied in various fields, such as health centers, subsidiaries and alliance thereof for providing services such as medical treatment and health counsel.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A security mechanism for one-time secured data access, comprising:
a token card, containing writable/readable tags;
a token access device, for accessing a token from the token card; and
a central system, for managing the token access device.

2. The security mechanism for one-time secured data access as recited in claim 1, wherein the tags in the token card are used for storing an identification number, a private key and the token.

3. The security mechanism for one-time secured data access as recited in claim 1, wherein the identification number, the private key and the token are issued from the central system.

4. The security mechanism for one-time secured data access as recited in claim 1, wherein the tags in the token card are contactless tags.

5. The security mechanism for one-time secured data access as recited in claim 4, wherein the contactless tags comprise at least one of RFID tags, contactless ID tags, sensor tags, RFID transponders and combination thereof.

6. The security mechanism for one-time secured data access as recited in claim 1, wherein the tags in the token card are re-writable/readable.

7. The security mechanism for one-time secured data access as recited in claim 1, wherein the token access device comprises:
a reader, for reading the tags in the token card;
a reader control module, for controlling the reader and coupled to the central system through Internet;
an authentication module, for an authentication process of the token card and coupled to the central system through Internet;
a data access processing module, for processing a data access process and coupled to the central system through Internet; and
an interface module, for communicating the token access device and a local service system.

8. The security mechanism for one-time secured data access as recited in claim 7, wherein the reader comprises a transceiver antenna, a transceiver module and a control circuit.

9. The security mechanism for one-time secured data access as recited in claim 7, wherein the reader control module is capable of controlling the reader to write/read and receiving the token transmitted from the central system.

10. The security mechanism for one-time secured data access as recited in claim 7, wherein the data access processing module is coupled to a display device.

11. The security mechanism for one-time secured data access as recited in claim 10, wherein the display device is coupled to the local service system coupled to the interface module.

12. The security mechanism for one-time secured data access as recited in claim 7, wherein the data access processing module is capable of performing decryption on information of the central system.

13. The security mechanism for one-time secured data access as recited in claim 7, wherein the local service system coupled to the interface module comprises a local service module for operating the local service system.

14. The security mechanism for one-time secured data access as recited in claim 1, wherein the token access device further comprises a token card cassette for communicating the token card and the token access device.

15. The security mechanism for one-time secured data access as recited in claim 1, wherein the central system comprises:
a token manager for managing the token;
a security manager for managing an authentication/authorization process;
a service manager for managing a service process; and
a database for storing data.

16. The security mechanism for one-time secured data access as recited in claim 15, wherein the token manager is used for managing generation, usage, invalidation of the token.

17. The security mechanism for one-time secured data access as recited in claim 15, wherein the token manager is used for transmitting the token to a local access point or a local service point.

18. The security mechanism for one-time secured data access as recited in claim 17, wherein the local access point comprises a web portal for providing network-linking for subscriber registration and adding, updating or deleting services.

19. The security mechanism for one-time secured data access as recited in claim 18, wherein the local access point comprises the token access device.

20. The security mechanism for one-time secured data access as recited in claim 15, wherein the security manager is used for authenticating identity of a card holder, verifying services allowed for the identity and managing information access privilege of each of the services.

21. The security mechanism for one-time secured data access as recited in claim 15, wherein the security manager is capable of performing encryption on information transmitted from the central system.

22. The security mechanism for one-time secured data access as recited in claim 15, wherein the service process managed by the service manager comprises managing subscriber registration and adding, updating or deleting services.

23. A subscriber registration process using a security mechanism for one-time secured data access, comprising steps of:
a. an applicant going to a local access point comprising a token access device;
b. the applicant providing a registration officer with identification and authorization documents;
c. the registration officer verifying the documents, taking a picture of the applicant and performing a security check on the applicant;
d. a central system verifying whether the applicant passes verification and the security check;
e. rejecting application if the applicant does not pass the verification and the security check and stopping the application process, otherwise proceeding with Step f;
f. creating and storing a personal profile of the applicant in the central system;
g. issuing a token card with a unique card holder ID and a private key to the applicant;
h. testing the token card and the overall system; and
i. the applicant successfully enrolling in the central system.

24. A token initialization process using a security mechanism for one-time secured data access, comprising steps of:
a. logging onto a web portal to select desired services;
b. choosing a token initialization option from the web portal;
c. placing a token card on a token card cassette of a token access device;
d. the token access device transmitting an ID and a private key to a central system for authentication;
e. the central system verifying whether the token card is valid;
f. rejecting the token card and stopping the initialization process if the central system verifies the token card is invalid, otherwise proceeding with Step g;
g. the central system creating a unique electronic token corresponding to the services selected by a card holder;
h. the central system transmitting the token to the requesting token access device and the token access device writing the electronic token into a tag memory of the token card;
i. the central system verifying whether the token is successfully written into the token card and returning to Step h if writing is failed, otherwise proceeding with Step j; and
j. the token being successfully written into the token card and the web portal displaying service related information.

25. A secured data access process using a local service point of a security mechanism for one-time secured data access, comprising steps of:
a. deciding a local service point to visit and going to the local service point;
b. placing a token card on a token access device in the local service point;
c. the token access device transmitting an ID and a private key to a central system for authentication;
d. the central system verifying whether the token card is valid;
e. rejecting a service and stopping the secured data access process if the central system verifies the token card is invalid, otherwise proceeding with Step f;
f. the token access device requesting information regarding a card holder by transmitting a token key and a corresponding local service ID to the central system;
g. the central system authenticating a request from the local service point by verifying the service ID and an electronic token (token string);
h. the central system verifying whether a valid service is matched with a valid token;
i. rejecting a service and stopping the secured data access process if the central system verifies the valid service is not matched with the valid token, otherwise proceeding with Step j;
j. the central system retrieving a specific portion of profile information of the card holder related to a specific local service from a database and associating the service ID with the token string;
k. the central system encoding the retrieved information and transmitting the encoded retrieved information to the requesting local service point;
l. the token access device of the requesting local service point receiving the encoded information, decoding the information, displaying the information and finally informing an associating local service system; and
m. the token access device clearing all data related to the token after the service ends and the token card is taken out of the token access device.
